(19) United States
(12) Patent Application Publication
(10) Pub. No.: US 2017/0287372 A1
(43) Pub. Date: Oct. 5, 2017

(54) BANNER SUPPORT ASSEMBLY

(71) Applicant: Wheels Automotive Dealer Supplies Inc., Stoney Creek (CA)

(72) Inventors: Rick Ashworth, Stoney Creek (CA); Scott Kobryn, Niagara-on-the-Lake (CA)

(21) Appl. No.: 15/452,983

(22) Filed: Mar. 8, 2017

Related U.S. Application Data
(60) Provisional application No. 62/316,026, filed on Mar. 31, 2016.

(51) Int. Cl. G09F 17/00; G09F 7/18

(52) U.S. Cl. CPC G09F 17/00; G09F 7/18; G09F 2007/1817; G09F 2007/1856

(57) ABSTRACT

The present invention is a banner support assembly for mounting to poles of any surface or shape. The banner support assembly includes a plurality of pole brackets abutting the outer surface of the pole which are demountably secured at preselected intervals around the pole with at least one band clamp received through band slots defined in each pole bracket. A ring is slideably received within a channel defined in each of the pole brackets such that the ring is free to rotate around the pole about a longitudinal axis of the pole.

The present application claims priority from U.S. Provisional application 62/316,026 filed on Mar. 31, 2016 by Rick Ashworth and Scott Kobryn under the title BANNER SUPPORT ASSEMBLY.

### FIELD OF THE INVENTION

The present concept relates to devices for attaching a flag to a pole and/or flag pole and more particular devices which permit the flag to revolve about the flag pole according to the direction of the wind without becoming wrapped around the pole.

### BACKGROUND OF THE INVENTION

There have been a number of attempts to design an attachment for flag poles and/or other poles which will prevent the flag from becoming entangled with the pole but these devices have disadvantages for a number of reasons that have resulted in most not being commercially feasible. In most cases the devices are overly complicated arrangements that require great amounts of maintenance in order to keep in operation. The other factor is that the cost and expense of installing these prior art devices is so high that it is not viable to use them.

Additionally flags are mounted not only onto flag poles but also onto other posts such as light posts and/or sign posts which have a number of different cross sectional shapes namely round, square and at times hexagonal. There is a need for a banner support assembly which is able to be attached to any type of cross section of pole at any height along the pole and that is simple to attach and inexpensive to manufacture.

There are a number of prior art devices which have attempted to solve one or more of the issues enumerated above namely U.S. Pat. No. 4,402,220 issued to Kuhlmann, U.S. Pat. No. 5,203,672 issued to Wolf, U.S. Pat. No. 5,361,633 issued to Peet, and U.S. Pat. No. 7,270,076 issued to Evans.

There is need to for a banner support assembly which is simply to install, which is inexpensive to manufacture, which is reliable in its operation, which resists corrosion and other effects of the weather upon the banner support assembly and will continue to operate with a minimal amount of maintenance.

### SUMMARY OF THE INVENTION

A banner support assembly for mounting to a pole comprising;
a) a pole which includes an outer surface;
b) a plurality of pole brackets abutting the outer surface of the pole and demount-ably secured at preselected intervals around the pole with at least one band clamp received through band slots defined in each pole bracket; and
c) a ring slide-ably received within a channel defined in each of the pole brackets such that the ring is free to rotate around the pole about a longitudinal axis of the pole.

Preferably wherein the pole bracket includes a mounting side contacting and abutting the pole outer surface and the channel includes a bearing surface for slideably supporting the ring thereon.

Preferably wherein the pole bracket is C shaped and defines a U shaped channel for receiving the ring therein.

Preferably wherein each pole bracket includes an upper band slot and a lower band slot for receiving band clamps there through such that two band clamps secure the pole brackets to the pole.

Preferably wherein the ring includes a removable segment which is demountable attached to the major segment in order to assemble the ring onto the channel of the pole brackets.

Preferably wherein two vertically spaced apart support assemblies an upper assembly and a lower assembly are mounted on a pole for attaching a flag frame to each ring of each assembly such that the rings and the flag frame rotate about the pole in unison.

Preferably wherein the flag frame includes a vertical strut extending parallel to the longitudinal direction and spaced from the pole and connected to an upper horizontal strut at an upper end with an upper connector and to a lower horizontal strut at a lower end.

Preferably wherein each connector includes a ring landing portion for abutting with and connecting to the ring.

Preferably wherein each connector includes vertical strut channel for receiving the vertical strut there through and a horizontal aperture for receiving a horizontal strut therein.

Preferably wherein the connector is L shaped with a vertical portion and a horizontal portion.

Preferably wherein the flag frame is C shaped.

Preferably wherein the pole is square in cross section and four pole brackets are deployed onto the pole.

Preferably wherein the pole is round in cross section and three pole brackets are deployed onto the pole.

Preferably wherein the pole is hexagonal in cross section and three pole brackets are deployed onto the pole.

### BRIEF DESCRIPTION OF THE DRAWINGS

FIG. 1 is cross sectional view of the present concept a banner support assembly shown deployed on a square pole.

FIG. 2 is cross sectional view of the present concept a banner support assembly shown deployed on a round pole.

FIG. 3 is cross sectional view of the present concept a banner support assembly shown deployed on a hexagonal pole.

FIG. 4 is a top perspective view showing a portion of the banner support assembly namely upper support assembly.

FIG. 5 is a side elevational view of the upper support assembly of the banner support assembly shown in FIG. 4.

FIG. 6 is a partial side elevational view showing the upper support assembly and the lower support assembly and parts of the flag frame.

FIG. 7 is a top perspective view of the banner support assembly.

FIG. 8 is a bottom perspective view of the banner support assembly.

FIG. 9 is a side elevational view of the banner support assembly shown complete with the upper support assembly, the lower support assembly and the flag frame.

FIG. 10 is a bottom perspective schematic view of the banner support assembly 100 deployed onto a light standard or pole.

### DETAILED DESCRIPTION OF THE PREFERRED EMBODIMENTS

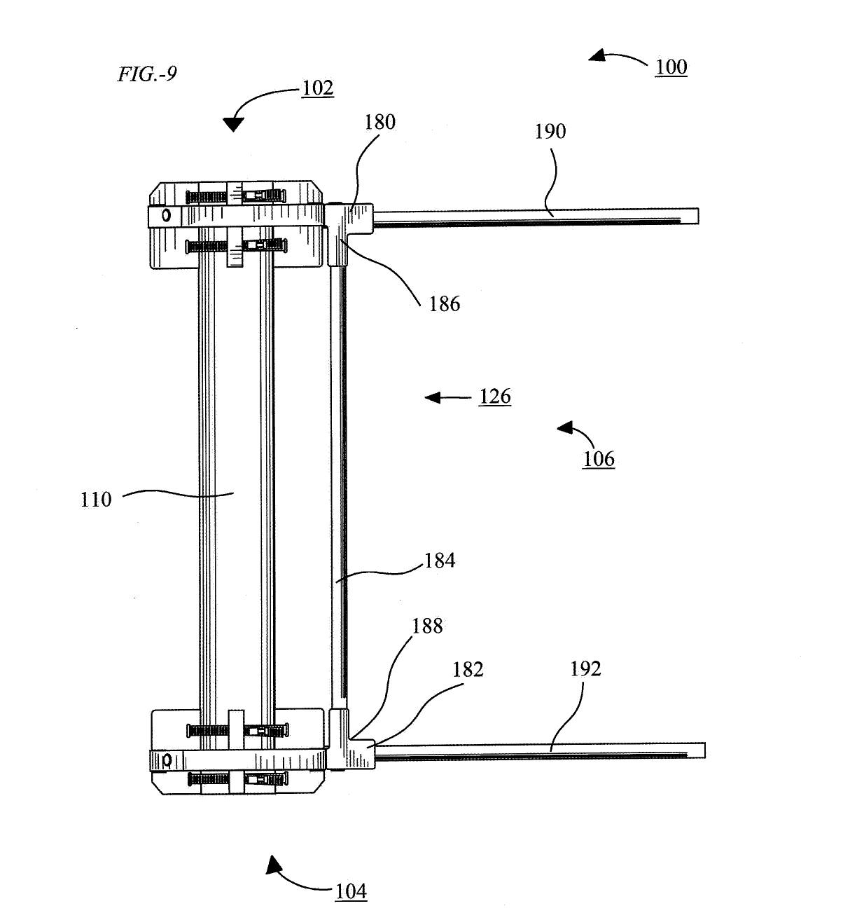

Referring first of all to FIG. 9 the banner support assembly shown generally as 100 includes the following major components namely; upper support assembly 102, lower support assembly 104, and flag frame 106.

Banner support assembly 100 is shown deployed on a pole 110 in FIG. 9.

The reader will note that upper support assembly 102 and lower support assembly 104 are very similar.

Therefore by way of example we will first discuss upper support assembly 102 however all of the items discussed in regard to upper support assembly 102 have identical counter parts in lower support assembly 104 as shown in the drawings.

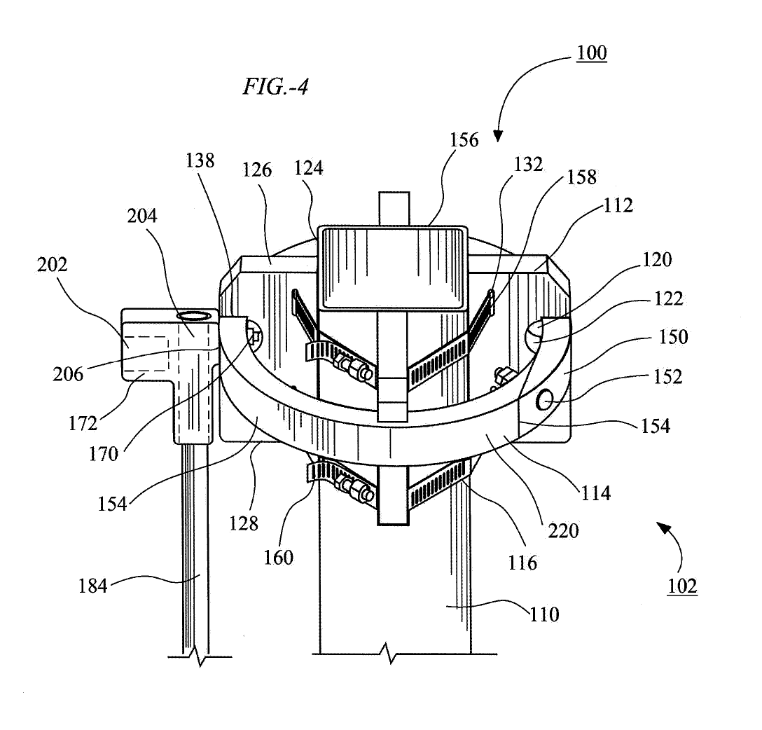

Banner support assembly 100 preferably includes two support assemblies namely upper support assembly 102 and lower support assembly 104. FIG. 4 depicts upper support assembly 102 and includes the following major components namely pole brackets 112 ring 114 and band clamps 116.

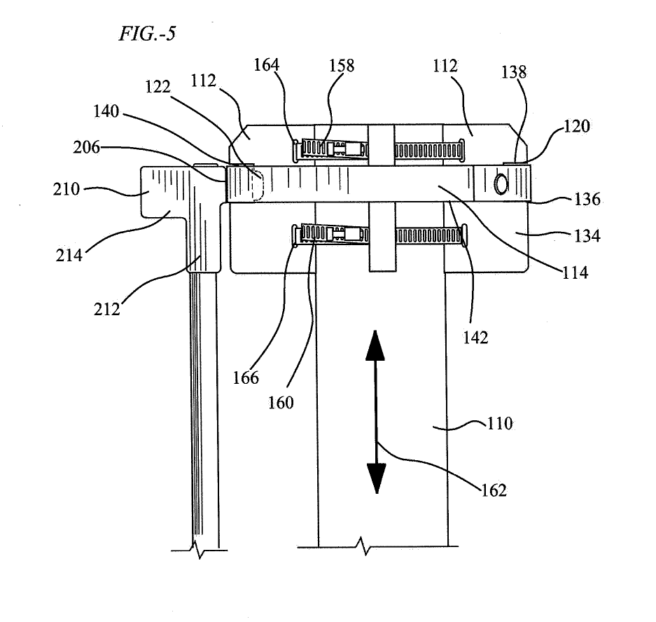

The structure of pole bracket 112 is best depicted in FIGS. 4 and 5 and therefore referring now to FIGS. 4 and 5 pole bracket 112 includes a ring channel 120, a relief 122 there behind the ring channel 120, a mounting side 124, a top side 126, a bottom side 128, a front side 130 and band slots 132.

Pole bracket 112 is preferably a “C” shaped bracket 134 as depicted in FIG. 5 wherein the bottom of ring channel 120 is bearing surface 136 and the top of ring channel 120 is retaining surface 138 and ring channel 120 roughly defines a “U” shaped ring channel 140.

Ring 114 is designed to be slideably received within ring channel 120 such that the ring bottom surface 142 slides along bearing surface 136 of ring channel 120 of each of the pole brackets 112. Ring 114 has a removable segment 150 which is attached with fasteners 152 to a major section 154 of ring 114.

Ring 114 has removable segment 150 in order to be able to mount it around pole 110. Ring 114 therefore includes two split lines 154 which is the connection point between the removable segment 150 and the major segment 154. The split line 154 is flush in other words there is no surface step in the ring bottom surface 142 and in particular when going from the major segment 154 of ring 114 to the removable segment 150.

Upper support assembly 102 is attached to an outer surface 156 of pole 110 using band clamp 116 which is fed through band slots 132.

It is possible that only one band clamp 116 is necessary in order to attach upper support assembly 102 to pole 110 however preferably two band clamps 116 are used namely upper band 158 and lower band 160 are used to mount the pole brackets 112 onto the outer surface 156 of pole 110.

The reader will note that the mounting side 124 of pole bracket 112 abuts against the outer surface 156 of pole 110 and is compressively held against the outer surface 156 of pole 110 by tightening and shortening the length of the band clamps 116. Therefore preferably there is an upper band 158 and a lower band 160 wherein the upper band 158 passes through upper slots 164 and the lower band 160 passes through lower slots 166.

Ring channel 120 also preferably has a relief 122 in order that the fastener 152 of ring 114 can pass there-through and also the fastener 170 of connector 172 may also pass through relief 122.

The reader will note that ring 114 is free to rotate about a longitudinal direction 162, as it slideably rides on bearing surface 136 of the pole brackets 112.

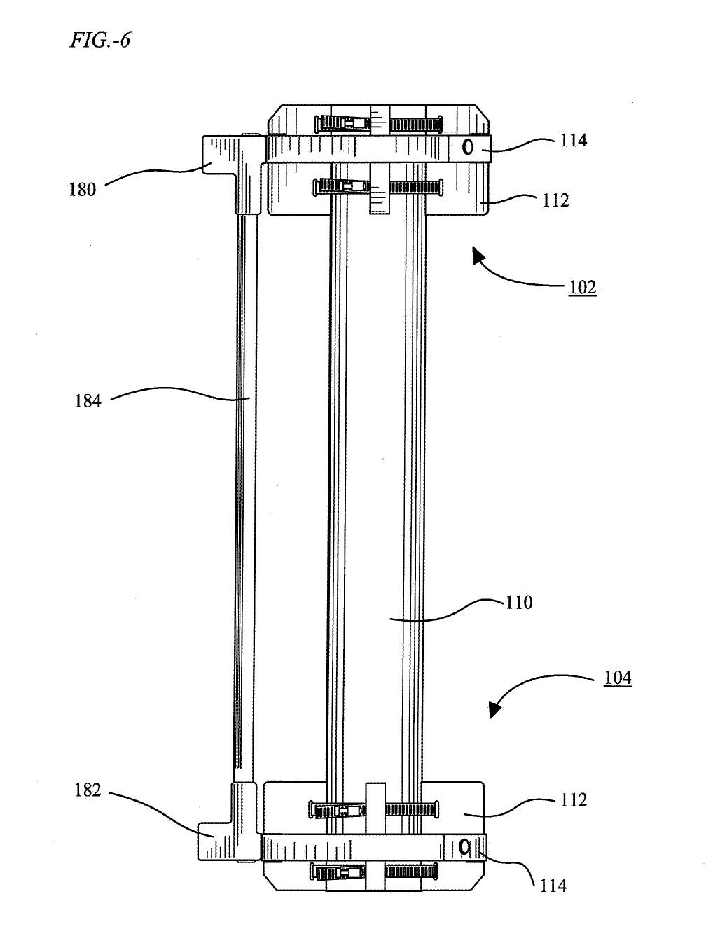

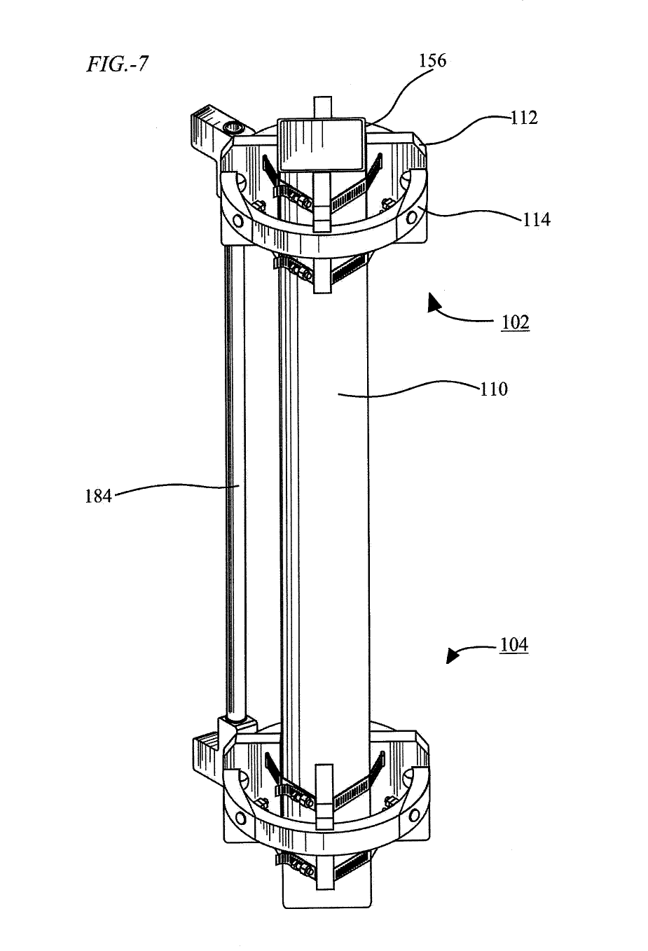

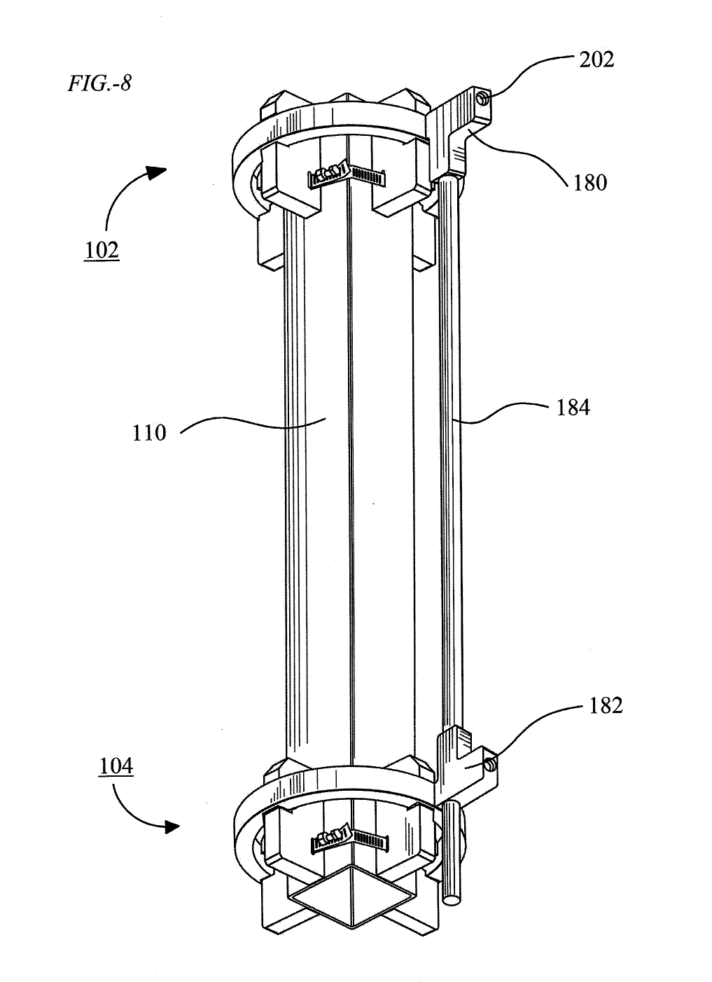

Referring to FIG. 6 the reader will note that preferably there are two support assemblies namely upper support assembly 102 and lower support assembly 104 which are attached to pole 110.

FIG. 9 depicts a flag frame 106 connected to the upper and lower support assemblies 102 and 104 respectively using upper connector 180 and a lower connector 182. A vertical strut 184 spans between upper connector 180 and 182 in the vertical direction wherein an upper end 186 of vertical strut 184 connects to upper connector 180 and a lower end 188 of vertical strut 184 connects to lower connector 182.

An upper horizontal strut 190 attached to upper connector 180 and extends perpendicularly away from pole 110 and vertical strut 184. Similarly a lower horizontal strut 192 is connecter to lower connector 182 and extends horizontally perpendicularly away from vertical strut 184 and pole 110.

Upper connector 180 and lower connector 182 is shown generally as connector 172.

Referring now to FIGS. 4 and 5, connector 172 includes a horizontal portion 210, a vertical portion 212 and is generally an “L” shaped connector as shown as 214. Upper connector 180 and lower connector 182 are the same other than lower connector 182 is the mirror image of upper connector 180 and is positioned inverted relative to upper connector 180.

The horizontal portion 210 of connector 172 includes a horizontal aperture 202 for receiving horizontal struts 190 and 192 therein.

The vertical portion 212 of connector 172 includes vertical strut channel 204 for receiving vertical strut 184 there-through.

Connector 172 is fastened to ring 114 at a ring landing portion 206 which abuts and contacts with the outer surface 220 of ring 114.

The reader will note flag frame 106 is a “C” shaped flag frame 126 as depicted in FIG. 9.

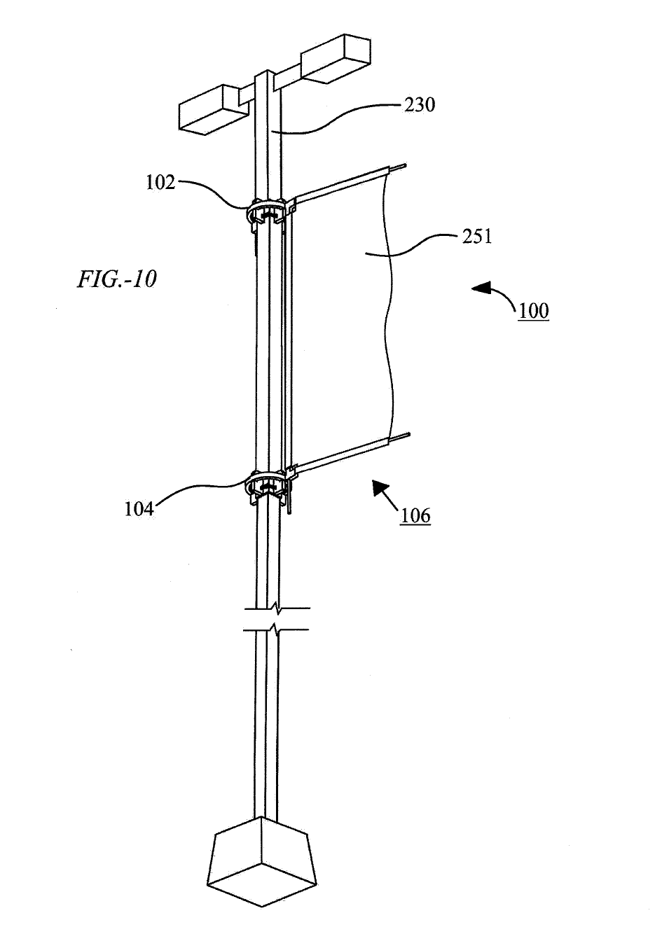

Referring to FIG. 10 the banner support assembly 100 is shown deployed onto a light pole or light standard 230 wherein upper support assembly 102 is connected to an upper portion of light pole 230 and lower support assembly 104 is connected to lower portion of light pole 230 and flag frame 106 is connected to both the upper support assembly 102 and lower support assembly 104 using connectors 172.

The flag frame 106 together with flag 251 is free to rotate around pole 110 since it is connected to rings 114 at both the upper support assembly 102 and lower support assembly 104.

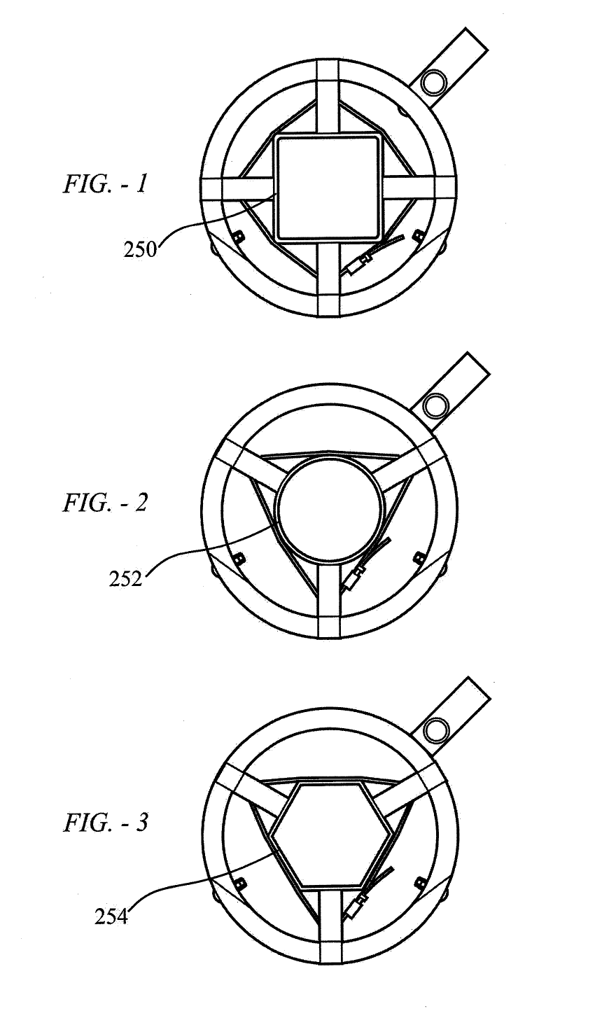

Referring now to FIGS. 1, 2 and 3 upper support assembly 102 is shown deployed onto a square pole 250 in FIG. 1, deployed onto round pole 252 in FIG. 2 and deployed onto a hexagonal pole 254 in FIG. 3.

It should be apparent to persons skilled in the arts that various modifications and adaptation of this structure described above are possible without departure from the spirit of the invention the scope of which defined in the appended claim.

I claim:

1. A banner support assembly for mounting to a pole, the banner support assembly comprises;
a) a pole which includes an outer surface;
b) a plurality of pole brackets abutting the outer surface of the pole and demount-ably secured at preselected intervals around the pole with at least one band clamp received through band slots defined in each pole bracket; and
c) a ring slide-ably received within a channel defined in each of the pole brackets such that the ring is free to rotate around the pole about a longitudinal axis of the pole.

2. The banner support assembly claimed in claim 1 wherein the pole bracket includes a mounting side contacting and abutting the pole outer surface and the channel includes a bearing surface for slideably supporting the ring thereon.

3. The banner support assembly claimed in claim 2 wherein the pole bracket is C shaped and defines a U shaped channel for receiving the ring therein.

4. The banner support assembly claimed in claim 3 wherein each pole bracket includes an upper band slot and a lower band slot for receiving band clamps there through such that two band clamps secure the pole brackets to the pole.

5. The banner support assembly claimed in claim 1 wherein the ring includes a removable segment which is demountable attached to the major segment in order to assemble the ring onto the channel of the pole brackets.

6. The banner support assembly claimed in claim 1, wherein two vertically spaced apart support assemblies an upper assembly and a lower assembly are mounted on a pole for attaching a flag frame to each ring of each assembly such that the rings and the flag frame rotate about the pole in unison.

7. The banner support assembly claimed in claim 6 wherein the flag frame includes a vertical strut extending parallel to the longitudinal direction and spaced from the pole and connected to an upper horizontal strut at an upper end with an upper connector and to a lower horizontal strut at a lower end.

8. The banner support assembly claimed in claim 1 wherein each connector includes a ring landing portion for abutting with and connecting to the ring.

9. The banner support assembly claimed in claim 8 wherein each connector includes vertical strut channel for receiving the vertical strut there through and a horizontal aperture for receiving a horizontal strut therein.

10. The banner support assembly claimed in claim 1 wherein the connector is L shaped with a vertical portion and a horizontal portion.

11. The banner support assembly claimed in claim 1 wherein the flag frame is C shaped.

12. The banner support assembly claimed in claim 1 wherein the pole is square in cross section and four pole brackets are deployed onto the pole.

13. The banner support assembly claimed in claim 1 wherein the pole is round in cross section and three pole brackets are deployed onto the pole.

14. The banner support assembly claimed in claim 1 wherein the pole is hexagonal in cross section and three pole brackets are deployed onto the pole.
